(19) United States
(12) Patent Application Publication
(10) Pub. No.: US 2018/0312685 A1
(43) Pub. Date: Nov. 1, 2018

(54) HIGH IMPACT POLYARYLETHERKETONE - POLYCARBONATE BLENDS

(71) Applicant: SABIC Global Technologies B.V., Bergen op Zoom (NL)

(72) Inventors: Robert Russell Gallucci, Mt. Vernon, IN (US); Hao Zhou, Mt. Vernon, IN (US)

(21) Appl. No.: 15/772,113

(22) PCT Filed: Oct. 26, 2016
(86) PCT No.: PCT/IB2016/056439

§ 371 Date: Apr. 30, 2018

Related U.S. Application Data
(60) Provisional application No. 62/248,603, filed on Oct. 30, 2015.

(51) Int. Cl. C08L 61/16; C08K 3/22; C08K 5/053; C08L 63/00; C08L 83/04; C08G 8/02

(52) U.S. Cl. CPC C08L 61/16; C08K 3/22; C08K 5/053; C08L 63/00; C08K 3/36; C08G 8/02; C08G 2650/40; C08K 2003/2241; C08K 2003/2227; C08L 83/04

(57) ABSTRACT

A polymer blend including: from 45 to 95 weight percent (wt %), preferably from 50 to 90 wt % of a polycarbonate having a weight average molecular weight greater than or equal to 25,000 g/mol and less than or equal to 80,000, preferably greater than or equal to 28,000 g/mol and less than or equal to 50,000, more preferably greater than or equal to 30,000 g/mol and less than or equal to 45,000; and from 5 to 55 wt %, preferably from 10 to 50 wt % of a polyaryletherketone; wherein the weight percentages are based on the total weight of the polymer blend; wherein an article molded from the polymer blend has a notched Izod impact strength greater than or equal to 400 J/m, preferably greater than or equal to 800 J/m, more preferably greater than or equal to 1000 J/m measured as per ASTM method D256-10 on a 3.2 millimeter (mm) thick sample.

### BACKGROUND

This disclosure relates generally to polymer blends, and in particular to polyaryletherketone—polycarbonate polymer blends, articles made from such polymer blends, methods of manufacture, and uses thereof.

Crystalline polyaryletherketone (PAEK) polymers, including, for example, polyaryl ether ketones, polyaryl ketones, polyether ketones and polyether ether ketones, have desirable properties, such as solvent resistance, low wear rate, abrasion resistance, and high strength. However the relatively low glass transition temperatures (Tg) of crystalline PAEK polymers limits their use at high temperatures under load.

There exists a need for polyaryletherketone formulations having one or more improved properties, for example high impact strength. It would further be advantageous if the formulations retained good melt processability.

### SUMMARY

The above-described and other deficiencies of the art are met by a polymer blend including: from 45 to 95 weight percent (wt %), preferably from 50 to 90 wt % of a polycarbonate having a weight average molecular weight greater than or equal to 25,000 g/mol and less than or equal to 80,000, preferably greater than or equal to 28,000 g/mol and less than or equal to 50,000, more preferably greater than or equal to 30,000 g/mol and less than or equal to 45,000; and from 5 to 55 wt %, preferably from 10 to 50 wt % of a polyaryletherketone; wherein the weight percentages are based on the total weight of the polymer blend; wherein an article molded from the polymer blend has a notched Izod impact strength greater than or equal to 400 J/m, preferably greater than or equal to 800 J/m, more preferably greater than or equal to 1000 J/m, measured as per ASTM method D256-10 on a 3.2 millimeter (mm) thick sample.

An article includes the above-described polymer blend. A method of preparing a polymer blend includes melt blending from 45 to 95 wt %, preferably from 50 to 90 wt % of a polycarbonate having a weight average molecular weight between 25,000 g/mol and 80,000 g/mol; and from 5 to 55 wt %, preferably from 10 to 50 wt % of a polyaryletherketone; wherein the weight percentages are based on the total weight of the polymer blend.

The manufacture of an article includes molding, extruding, or shaping the above-described polymer blend into an article.

The above-described and other features are exemplified by the following drawing, detailed description, examples, and claims.

### BRIEF DESCRIPTION OF THE DRAWINGS

Referring now to the drawings, which are exemplary and not limiting.

FIG. 1 shows melt stability data for four polycarbonate (PC)-polyether ether ketone (PEEK) polymer blends heated to 360° C. and held at this temperature for 30 minutes. At least 70% of the initial melt viscosity was retained during the high temperature exposure for these polymer blends.

FIG. 2 shows flexural modulus vs. temperature for PEEK and three PC-PEEK copolymer blends as measured by Dynamic Mechanical Analysis (DMA).

### DETAILED DESCRIPTION

Described herein is a polymer blend including a high molecular weight polycarbonate and a polyaryletherketone. Articles molded from the polymer blend can have excellent physical properties including one or more of good dimensional stability, good retention of viscosity, good chemical resistance, high impact resistance, and good processability.

A “high impact” polymer blend has, e.g., an impact resistance (or impact strength) greater than the impact resistance of the polyaryletherketone polymer component alone. For example, a polymer blend as described herein can be obtained where the notched Izod impact strength of aged molded bars, as measured by ASTM D256-10 on a 3.2 mm thick sample is greater than or equal to 400 J/m, preferably greater than or equal to 800 J/m, more preferably greater than or equal to 1000 J/m. The polymer blends described herein can be high impact polymer blends. The polymer blends described herein can be, e.g., uniform high impact polymer blends wherein the blends fail in a ductile manner (i.e., after impact in a notched Izod test pursuant to ASTM D256-10, using a 3.2 mm thick test bar formed from the polymer blend). The bar shows plastic deformation of the polymer blends around the notch and while the part is cracked it remains in one piece.

As used herein, a “high molecular weight” polycarbonate means the weight average molecular weight of the polycarbonate is between 25,000 g/mol and 100,000 g/mol. A high molecular weight polycarbonate has, e.g., a molecular weight between 28,000 g/mol and 80,000 g/mol. A high molecular weight polycarbonate has, e.g., a molecular weight between 35,000 g/mol and 60,000 g/mol. A high molecular weight polycarbonate has, e.g., a molecular weight between 25,000 g/mol and 50,000 g/mol. A high molecular weight polycarbonate has, e.g., a molecular weight between 28,000 g/mol and 45,000 g/mol. A high molecular weight polycarbonate has, e.g., a molecular weight between 30,000 g/mol and 40,000 g/mol. As used herein, the molecular weights are weight average molecular weight (Mw) measured by gel permeation chromatography (GPC) using polycarbonate standards. The polycarbonates used and described herein are high molecular weight polycarbonates. Use of lower molecular weight polycarbonate polymers can result in inferior mechanical properties such as reduced impact strength, and can further result in difficult melt compounding with poor mixing and extrusion of the blends.

The polymer blends are, e.g., phase separated blends of a polyaryletherketone and a high molecular weight polycarbonate. Although Applicant is not required to provide a description of any theory of the operation and the appended claims should not be limited by applicant statements regarding such theory, it is thought that the presence of at least two separate polymeric phases with some limited mutual affinity contributes to the improvement in properties. Limited mutual affinity is such that the attraction of the polymers is such that while they have good interfacial adhesion the attraction is not so much that they lose phase separation and dissolve in each other to a major (>10%) extent.

As used herein, “phase separated” means that the polyaryletherketone and the high molecular weight polycarbonate component of the polymer blend exist in admixture as separate distinct physical domains dissolved that can be distinguished using standard analytical techniques, for example microscopy, differential scanning calorimetry (DSC), or dynamic mechanical analysis (DMA), to show at least two distinct polymeric phases, one of which includes the polyaryletherketone and one of which includes the high molecular weight polycarbonate. The phases can, e.g., contain a minor amount of the other polymer therein, which can be up to 20 wt % of the phase. The polymer blends can, e.g., form separate distinct domains (phases) from about 0.1 to 50 micrometers in size, optionally from about 0.1 to 20 micrometers. The size can be determined by microscopy, for example by calculating the average largest diameter of each domain in a cross-section sample microtomed from an injection molded part. The polymer blends can be completely immiscible or can show partial miscibility, but at least in the solid state, the polymer blend shows two or more distinct polymeric phases. In some examples, the polyarylether ketone phase shows a crystalline melting point of from 230 to 300° C. In other examples the polyarylether ketone shows a crystalline melting point of from 250 to 300° C.

The polymer blend can have, e.g., at least two distinct glass transition temperatures (Tg). Without being bound by theory, it is believed that the first Tg is from the polyaryletherketone, or a partially miscible blend of a polyaryletherketone and a high molecular weight polycarbonate, and the second Tg is from the high molecular weight polycarbonate, or a second partially miscible blend of a polyaryletherketone and a high molecular weight polycarbonate. These glass transition temperatures can be measured by any conventional method such as DSC or DMA. The first Tg can be, e.g., from 110 to 165° C., preferably from 120 to 155° C., and the second Tg can be, e.g., from 150 to 260° C., preferably from 160 to 250° C. Depending on, e.g., the specific polymers, molecular weights, and manufacturing parameters for the polymer blend, the Tgs can be, e.g., distinct or the transitions can partially overlap.

The ratio of polyaryletherketone to the high molecular weight polycarbonate can be any ratio that results in a polymer blend that has an improved property depending on the end use application, compared to the properties of either the polyaryletherketone or the high molecular weight polycarbonate alone. Blends of the polymers will be opaque.

The properties of the final polymer blend can be adjusted by changing the ratios of polymers and the use of optional additives. Although Applicant is not required to provide a description of any theory of the operation and the appended claims should not be limited by applicant statements regarding such theory, it is thought the higher Mw polycarbonate is present, e.g., in an amount effective to increase the impact resistance of the polymer blend as compared to the impact resistance of the polyaryletherketone alone. For example, higher levels (greater than (>) 60 wt %) of the higher Mw polycarbonate will give less shrinkage and better dimensional stability but with some loss of chemical resistance. Higher polycarbonate content will also give better color, lower yellowness (for example as measured by a reduced Yellowness Index (YI) as per ASTM E313-15of at least one unit) and lower density (for example a density reduction of at least 5% as per ASTM D792-00).

The polymers in the polymer blend can be combined by any method that will result in a polymer blend as described herein. Such methods include, for example, melt blending, extrusion, sintering, pressure forming, and other methods. Twin screw extrusion is a preferred method. During compounding the melt temperature should be sufficient to completely melt the polyarylether ketone, usually 15 to 30° C. above the peak melting point (Tm) of the PAEK crystalline phase, but below 400° C. so as not to significantly degrade the polycarbonate polymer. To facilitate such compounding conditions and obtain full dispersion and mixing of the polymers, a high molecular weight, high viscosity polycarbonate is needed. It is also very helpful to use a granular or powder form of the PAEK. The use of PAEK pellets makes mixing and dispersion of the blend more difficult. Use of a lower molecular weight, lower melt viscosity, polycarbonate, and/or use of PAEK pellets, can result in poor mixing and can result in an unmelted portion of the PAEK.

“Polyaryletherketone” (PAEK) is a class of polymers including several polymer types containing aromatic rings, usually phenyl rings, linked primarily by ketone and ether groups in different sequences. Examples of polyaryletherketones include, but are not limited to, polyaryl ether ketone polymers themselves, polyether ketones (PEK), polyether ether ketones (PEEK), polyether ketone ether ketone ketones (PEKEKK) and polyether ketone ketones (PEKK) and copolymers containing such groups as well as combinations comprising at least one of the foregoing. Polyaryletherketones can include monomer units containing an aromatic ring, usually a phenyl ring, a ketone group, and an ether group in any sequence. Low levels, for example less than 10 mole %, of addition linking groups can be present as long as they do not fundamentally alter the properties of the polyaryletherketone. PEEK is commercially available from Victrex Ltd. as VICTREX PEEK. PEKEKK is commercially available from BASF Co. as ULTRAPEK. Polyether ether ketones are also available under the GATONE and KETASPIRE trade names from Solvay Co. and Solvay Advanced Polymers.

Several polyaryletherketones which are highly crystalline, with melting points above 300° C., e.g., can be used in the polymer blends. Examples of these crystalline polyaryletherketones, specifically polyphenyletherketones, are shown in the structures (I), (II), (III), (IV), and (V) below.

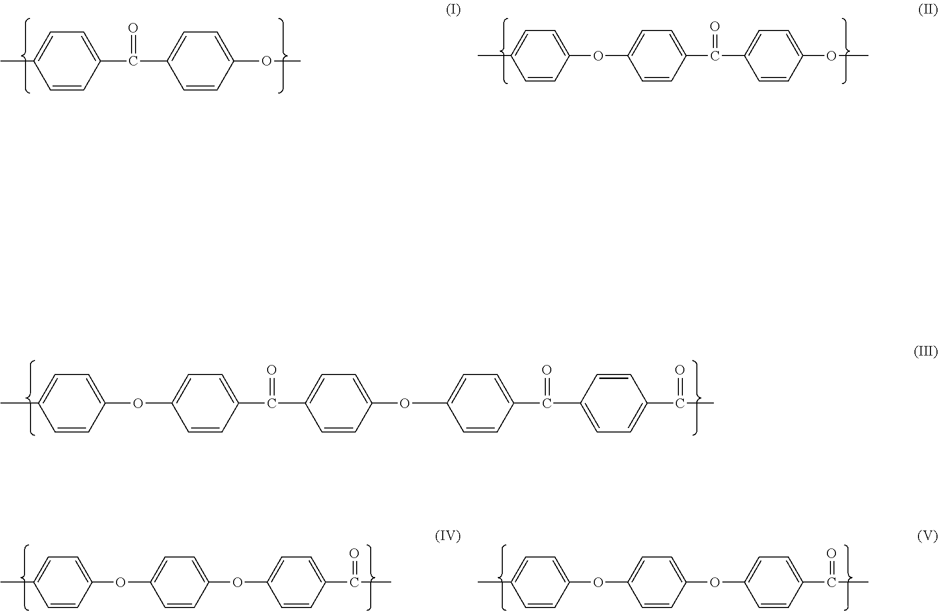

Other examples of crystalline polyaryletherketones which are suitable can be generically characterized as containing repeating units of the following formula (VI):

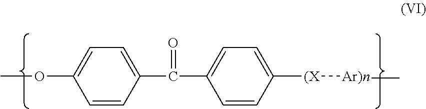

wherein each Ar is independently a divalent aromatic radical selected from phenylene, biphenylene or naphthylene, X is independently —O—, —C(O)—, or a direct bond, and n is an integer of from 0 to 3.

Polyaryletherketones can be prepared by methods well known in the art. One such method includes heating a substantially equimolar mixture of at least one bisphenol, often reacted as its bis-phenolate salt, and at least one of either a dihalobenzoid compound or, in other cases, at least one halophenol compound can be reacted to form the polymer. In other instances mixtures of these compounds can be used. For example hydroquinone can be reacted with a dihalo aryl ketone, such a dichloro benzophenone or difluoro benzophenone to form a polyaryl ether ketone. In other cases dihydroxy aryl ketone, such as dihydroxy benzophenone can be polymerized with aryl dihalides such as dichloro benzene to form PAEK polymers. In still other instances dihydroxy aryl ethers, such as dihydroxy diphenyl ether can be reacted with dihalo aryl ketones, such as difluoro benzophenone. In other variations dihydroxy compounds with no ether linkages, such as dihydroxy biphenyl or hydroquinone can be reacted with dihalo compounds which can have both ether and ketone linkages, for instance bis-(dichloro phenyl)benzophenone. In other instances diaryl ether carboxylic acids or carboxylic acid halides can be polymerized to form polyaryletherketones. Examples of such compounds are diphenylether carboxylic acid, diphenyl ether carboxylic acid chloride, phenoxy-phenoxy benzoic acid, and mixtures thereof. In still other instances dicarboxylic acids or dicarboxylic acid halides can be condensed with diaryl ethers, for example iso- or terephthaloyl chlorides (or mixtures thereof) can be reacted with diphenyl ether, to form polyaryletherketone polymers.

Polyaryletherketones can be prepared by other processes. U.S. Pat. No. 3,065,205 describes, for example, the electrophilic aromatic substitution (e.g., Friedel-Crafts catalyzed) reaction of aromatic diacyl halides with unsubstituted aromatic compounds such as diphenyl ether. A broad range of polymers can be formed, for example, by the nucleophilic aromatic substitution reaction of an activated aromatic dihalide and an aromatic diol or salt thereof, as shown, for example, in U.S. Pat. No. 4,175,175. U.S. Pat. No. 4,176,222 describes, for example, heating in the temperature range of 100 to 400° C., a substantially equimolar mixture of: (a) at least one bisphenol; and, (b.i) at least one dihalobenzenoid compound, and/or (b.ii) at least one halophenol, in which in the dihalobenzenoid compound or halophenol, the halogen atoms are activated by —C═O— groups ortho or para thereto, with a mixture of sodium carbonate or bicarbonate and a second alkali metal carbonate or bicarbonate, the alkali metal of said second alkali metal carbonate or bicarbonate having a higher atomic number than that of sodium, the amount of the second alkali metal carbonate or bicarbonate being such that there are 0.001 to 0.2 gram atoms of the alkali metal of higher atomic number per gram atom of sodium, the total amount of alkali metal carbonate or bicarbonate being such that there is at least one alkali metal atom for each phenol group present, and thereafter separating the polymer from the alkali metal halide. Another example is a process in which reactants such as: (a) a dicarboxylic acid; (b) at least one divalent aromatic radical and at least one mono aromatic dicarboxylic acid and, (c) combinations of (a) and (b), are reacted in the presence of a fluoroalkane sulfonic acid, particularly trifluoromethane sulfonic acid. See, for example, U.S. Pat. No. 4,396,755. Additional polyaryletherketones can be prepared according to a process wherein aromatic diacyl compounds are polymerized with at least one aromatic compound and at least one mono acyl halide as described in, for example, U.S. Pat. No. 4,398,020.

The polyaryletherketone is, e.g., a polyaryl ether ketone, polyaryl ketone, polyether ketone, polyether ether ketone, or a combination comprising at least one of the foregoing. A polyaryletherketone is, e.g., a polyether ether ketone. Any polyaryletherketone class polymer can be used which will have an improved property when blended with a high molecular weight polycarbonate as compared to the polyaryletherketone without the high molecular weight polycarbonate, as described herein. The polyaryletherketone can be, e.g., one or more polymers from any of the several classes of polyaryletherketone polymers described herein. A polyaryletherketone can have, e.g., a melt flow rate of between 100 Pascal-second (Pa-sec) and 500 Pa-sec at 400° C., preferably between 200 and 400 Pa-sec at 400° C., as measured by ISO11443. The polyaryletherketone can have, e.g., a melting temperature (Tm) from 300 to 360° C. The polyaryletherketone can have, e.g., less than 50 ppm phenolic end groups. In some instances, the PAEK can have a sodium content below 500 ppm. In other instances, the PAEK can have sodium content below 200 ppm. Many sodium salts, for example sodium carboxylates and sodium carbonates, can have a detrimental effect on polycarbonate melt stability at temperatures of 300° C. or higher needed to make the PAEK blends.

“Polycarbonate” means a polymer or copolymer having repeating structural carbonate units of formula (1)

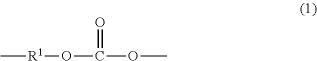

wherein at least 60 percent of the total number of R¹ groups are aromatic, or each R¹ contains at least one C₆₋₃₀ aromatic group. Specifically, each R¹ can be derived from a dihydroxy compound such as an aromatic dihydroxy compound of formula (2) or a bisphenol of formula (3).

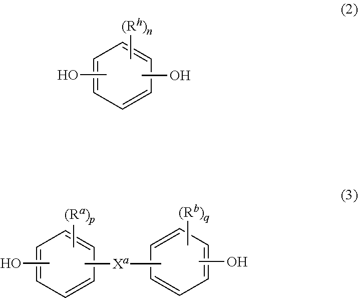

In formula (2), each R^{h} is independently a halogen atom, for example bromine, a C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4.

In formula (3), R^{a} and R^{b} are each independently a halogen, C₁₋₁₂ alkoxy, or C₁₋₁₂ alkyl, and p and q are each independently integers of 0 to 4, such that when p or q is less than 4, the valence of each carbon of the ring is filled by hydrogen. In an embodiment, p and q is each 0, or p and q is each 1, and R^{a} and R^{b} are each a C₁₋₃ alkyl group, specifically methyl, disposed meta to the hydroxy group on each arylene group. X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group, for example, a single bond, —O—, —S—, —S(O)—, —S(O)₂—, —C(O)—, or a C₁₋₁₈ organic group, which can be cyclic or acyclic, aromatic or non-aromatic, and can further comprise heteroatoms such as halogens, oxygen, nitrogen, sulfur, silicon, or phosphorous. For example, X^{a} can be a substituted or unsubstituted C₃₋₁₈ cycloalkylidene; a C₁₋₂₅ alkylidene of the formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(═R^{e})— wherein R^{e} is a divalent C₁₋₁₂ hydrocarbon group.

Some illustrative examples of specific dihydroxy compounds include the following: bisphenol compounds such as 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha,alpha'-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorene, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole; resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like.

Specific dihydroxy compounds include resorcinol, 2,2-bis(4-hydroxyphenyl) propane (“bisphenol A” or “BPA”, in which in formula (4): HO—A¹—Y¹—A²—OH (4) each of A^{l} and A² is p-phenylene and Y¹ is isopropylidene), 3,3-bis(4-hydroxyphenyl) phthalimidine, 2-phenyl-3,3′-bis(4-hydroxyphenyl) phthalimidine (also known as N-phenyl phenolphthalein bisphenol, “PPPBP”, or 3,3-bis(4-hydroxyphenyl)-2-phenylisoindolin-l-one), 1,1-bis(4-hydroxy-3-methylphenyl)cyclohexane, and 1,1-bis(4-hydroxy-3-methylphenyl)-3,3,5-trimethylcyclohexane (isophorone bisphenol).

“Polycarbonate” also includes copolymers comprising carbonate units and ester units (“poly(ester-carbonate)s”, also known as polyester-polycarbonates). Poly(ester-carbonate)s further contain, in addition to recurring carbonate chain units of formula (1), repeating ester units of formula (5)

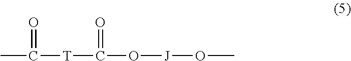

wherein J is a divalent group derived from a dihydroxy compound (which includes a reactive derivative thereof), and can be, for example, a C₂₋₁₀ alkylene, a C₆₋₂₀ cycloalkylene a C₆₋₂₀ arylene, or a polyoxyalkylene group in which the alkylene groups contain 2 to 6 carbon atoms, specifically, 2, 3, or 4 carbon atoms; and T is a divalent group derived from a dicarboxylic acid (which includes a reactive derivative thereof), and can be, for example, a C₂₋₂₀ alkylene, a C₆₋₂₀ cycloalkylene, or a C₆₋₂₀ arylene. Copolyesters containing a combination of different T and/or J groups can be used. The polyester units can be branched or linear.

Specific dihydroxy compounds include aromatic dihydroxy compounds of formula (2) (e.g., resorcinol), bisphenols of formula (3) (e.g., bisphenol A), a C₁₋₈ aliphatic diol such as ethane diol, n-propane diol, i-propane diol, 1,4-butane diol, 1,6-cyclohexane diol, 1,6-hydroxymethylcyclohexane, or a combination comprising at least one of the foregoing dihydroxy compounds. Aliphatic dicarboxylic acids that can be used include C₆₋₂₀ aliphatic dicarboxylic acids (which includes the terminal carboxyl groups), specifically linear C₈₋₁₂ aliphatic dicarboxylic acid such as decanedioic acid (sebacic acid); and alpha, omega-C₁₂ dicarboxylic acids such as dodecanedioic acid (DDDA). Aromatic dicarboxylic acids that can be used include terephthalic acid, isophthalic acid, naphthalene dicarboxylic acid, 1,6-cyclohexane dicarboxylic acid, or a combination comprising at least one of the foregoing acids. A combination of isophthalic acid and terephthalic acid wherein the weight ratio of isophthalic acid to terephthalic acid is 91:9 to 2:98 can be used.

Specific ester units include ethylene terephthalate units, n-propylene terephthalate units, n-butylene terephthalate units, ester units derived from isophthalic acid, terephthalic acid, and resorcinol (ITR ester units), and ester units derived from sebacic acid and bisphenol A. The molar ratio of ester units to carbonate units in the poly(ester-carbonate)s can vary broadly, for example 1:99 to 99:1, specifically, 10:90 to 90:10, more specifically, 25:75 to 75:25, or from 2:98 to 15:85.

A specific copolycarbonate includes bisphenol A and bulky bisphenol carbonate units, i.e., derived from bisphenols containing at least 12 carbon atoms, for example 12 to 60 carbon atoms or 20 to 40 carbon atoms. Examples of such copolycarbonates include copolycarbonates comprising bisphenol A carbonate units and 2-phenyl-3,3′-bis(4-hydroxyphenyl) phthalimidine carbonate units (a BPA-PPPBP copolymer, commercially available under the trade designation XHT from the Innovative Plastics division of SABIC).

Other specific polycarbonates that can be used include an isoindolinone polycarbonate copolymer (P3PC) of 3,3′-bis-(4-hydroxy phenyl)-2-phenyl isoindolin-1-one, also known as N-phenyl bisphenolphthalein, and bisphenol A. P3PC can be made, e.g., from the reaction of about 51 mole % bisphenol A (BPA) with about 49 mole % N-phenyl phenolphthalein bisphenol and about an equal molar amount (100 mole %) of phosgene to form carbonate linkages. In some instances the isoindolinone polycarbonate copolymer is end capped with p-cumyl phenol. In other instances the isoindolinone polycarbonate copolymer is capped with phenol or t-butyl phenol. Molecular weight can be controlled using such end caps to vary from, for example, 20,000 to 80,000 Daltons.

Other specific polycarbonates that can be used include poly(ester-carbonate)s comprising bisphenol A carbonate units and isophthalate-terephthalate-bisphenol A ester units, also commonly referred to as poly(carbonate-ester)s (PCE) or poly(phthalate-carbonate)s (PPC), depending on the relative ratio of carbonate units and ester units. Polyarylate copolymers, with carbonate linkages in addition to the aryl ester linkages, known as polyester-carbonates, are also useful. These polymers may be used alone or in combination with each other or more preferably in combination with bisphenol polycarbonates. These polymers can be prepared in solution or by melt polymerization from aromatic dicarboxylic acids or their ester forming derivatives and bisphenols and their derivatives. Suitable dicarboxylic acids are iso and terephthalic acid, their esters or acid chlorides. A preferred bisphenol is bisphenol A or its diacetate derivative. Polyester carbonates and polyarylates may also contain linkages derived from hydroxy carboxylic acids such as hydroxy benzoic acid. The most preferred polyester carbonate and polyarylates are derived from bisphenol A and mixture of iso- and terephthalic acid and are amorphous polymers. The polyester carbonates can be end capped with p-cumyl phenol. The polyester carbonates can be end capped with phenol or t-butyl phenol. Molecular weight can be controlled using such end caps to vary from, for example, 20,000 to 80,000 Daltons. Polyester carbonates are described, for example, in U.S. Pat. Nos. 3,169,121; 4,156,069 and 4,269,731. U.S. Pat. No. 4,663,421, e.g., describes suitable polyarylates.

“Polycarbonates” includes homopolycarbonates (wherein each R¹ in the polymer is the same), copolymers comprising different R¹ moieties in the carbonate (“copolycarbonates”), and copolymers comprising carbonate units and other types of polymer units, such as ester units.

Polycarbonates [and poly(ester-carbonate)s] can be manufactured by processes such as interfacial polymerization. Although the reaction conditions for interfacial polymerization can vary, an exemplary process generally involves dissolving or dispersing a dihydroxy compound in aqueous NaOH or KOH, adding the resulting mixture to a water-immiscible solvent, and contacting the reactants with a carbonate precursor in the presence of a catalyst such as, for example, a tertiary amine or a phase transfer catalyst, under controlled pH conditions, e.g., 8 to 10. The water-immiscible solvent can be, for example, methylene chloride, 1,2-dichloroethane, chlorobenzene, toluene, and the like.

The carbonate precursor can be a carbonyl halide, a bishaloformate of a dihydroxy compound, or a diaryl carbonate. The carbonyl halide can be carbonyl bromide or carbonyl chloride (phosgene). The bischloroformate can be the bischloroformate of bisphenol A, hydroquinone, ethylene glycol, neopentyl glycol, or the like. The diaryl carbonate can be a diaryl carbonate of formula (6)

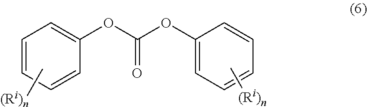

wherein n is an integer 1 to 3 and each R′ is independently a linear or branched, optionally substituted C₁₋₃₄ alkyl (specifically C₁₋₆ alkyl, more specifically C₁₋₄ alkyl), C₁₋₃₄ alkoxy (specifically C₁₋₆ alkoxy, more specifically C₁₋₄ alkoxy), C₅₋₃₄ cycloalkyl, C₇₋₃₄ alkylaryl C₆₋₃₄ aryl, a halogen (specifically a chlorine), or —C(═O)OR′ wherein R′ is H, linear or branched C₁₋₃₄ alkyl (specifically C₁₋₆ alkyl, more specifically C₁₋₄ alkyl), C₁₋₃₄ alkoxy (specifically C₁₋₁₆ alkoxy, specifically C₁₋₄ alkoxy), C₅₋₃₄ cycloalkyl, C₇₋₃₄ alkylaryl, or C₆₋₃₄ aryl. In an embodiment, the diaryl carbonate is diphenyl carbonate, or a diaryl carbonate wherein one or both aryl groups have an electron-withdrawing substituents, for example bis(4-nitrophenyl)carbonate, bis(2-chlorophenyl)carbonate, bis(4-chlorophenyl)carbonate, bis(methyl salicyl)carbonate, bis(4-methylcarboxylphenyl) carbonate, bis(2-acetylphenyl) carboxylate, bis(4-acetylphenyl) carboxylate. A molar ratio of diaryl carbonate to dihydroxy compound can be 2:1 to 1:2, or 1.5:1 to 1:1.5, or 1.05:1 to 1:1.05, or 1:1. In an embodiment, the molar ratio of the diaryl carbonate to the dihydroxy compound when expressed to three decimal places is 0.996 or less, or 0.962 to 0.996, or 0.968 to 0.996, or 0.971 to 0.994.

Combinations comprising at least one of the above described types of carbonate precursors can be used. An interfacial polymerization reaction to form carbonate linkages can use phosgene as a carbonate precursor, and is referred to as a phosgenation reaction. In the manufacture of polyester-polycarbonates by interfacial polymerization, rather than using the dicarboxylic acid or diol per se, the reactive derivatives of the acid or diol, such as the corresponding acid halides, in particular the acid dichlorides and the acid dibromides can be used. Thus, for example, instead of using isophthalic acid, terephthalic acid, or a combination comprising at least one of the foregoing acids, isophthaloyl dichloride, terephthaloyl dichloride, or a combination comprising at least one of the foregoing dichlorides can be used.

Among tertiary amines that can be used as catalysts in interfacial polymerization are aliphatic tertiary amines such as triethylamine and tributylamine, cycloaliphatic tertiary amines such as N,N-diethyl-cyclohexylamine, and aromatic tertiary amines such as N,N-dimethylaniline. Among the phase transfer catalysts that can be used are catalysts of the formula (R³)₄Q⁺X, wherein each R³ is the same or different, and is a C₁₋₁₀ alkyl; Q is a nitrogen or phosphorus atom; and X is a halogen atom or a C₁₋₈ alkoxy or C₆₋₁₈ aryloxy. Exemplary phase transfer catalysts include (CH₃(CH₂)₃)₄NX, (CH₃(CH₂)₃)₄PX, (CH₃(CH₂)₅)₄NX, (CH₃(CH₂)₆)₄NX, (CH₃(CH₂)₄)₄NX, CH₃(CH₃(CH₂)₃)₃NX, and CH₃(CH₃(CH₂)₂)₃NX, wherein X is Cl⁻, Br⁻, a C₁₋₈ alkoxy or a C₆₋₁₈ aryloxy. An effective amount of a phase transfer catalyst can be 0.1 to 10 wt %, or 0.5 to 2 wt %, each based on the weight of dihydroxy compound in the phosgenation mixture.

Branched polycarbonate blocks can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxyphenylethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents can be added at a level of 0.05 to 2.0 wt %. Combinations comprising linear polycarbonates and branched polycarbonates can be used.

An end-capping agent (also referred to as a chain stopper agent or chain terminating agent) can be included during polymerization to provide end groups. The end-capping agent (and thus the end groups) are selected based on the desired properties of the polycarbonates. Exemplary end-capping agents are exemplified by monocyclic phenols such as phenol and C₁₋₂₂ alkyl-substituted phenols such as p-cumyl-phenol, resorcinol monobenzoate, and p-and tertiary-butyl phenol, monoethers of diphenols, such as p-methoxyphenol, and alkyl-substituted phenols with branched chain alkyl substituents having 8 to 9 carbon atoms, 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, mono-carboxylic acid chlorides such as benzoyl chloride, C₁₋₂₂ alkyl-substituted benzoyl chloride, tolyl chloride, bromobenzoyl chloride, cinnamoyl chloride, and 4-nadimidobenzoyl chloride, polycyclic, mono-carboxylic acid chlorides such as trimellitic anhydride chloride, and naphthoyl chloride, functionalized chlorides of aliphatic monocarboxylic acids, such as acryloyl chloride and methacryoyl chloride, and mono-chloroformates such as phenyl chloroformate, alkyl-substituted phenyl chloroformates, p-cumyl phenyl chloroformate, and toluene chloroformate. Combinations of different end groups can be used.

Interfacial polymerization processes to produce polycarbonate produce a mixture of an aqueous (brine) phase that generally comprises water, ions, and catalyst and an organic (polymer) phase that comprises the polycarbonate and solvent, as well as catalyst and ions. The polycarbonate can be recovered from the organic phase via a process comprising a series of steps as described herein.

A combination comprising one, two, or more different high molecular weight polycarbonates can be used, and is referred to herein as a “polycarbonate.” A high molecular weight polycarbonate can contain, e.g., less than 25 parts per million (ppm) of hydroxyl phenolic end groups, preferably less than 20 ppm of hydroxyl phenolic end groups. A high molecular weight polycarbonate can contain, e.g., less than 100 ppm of benzylic protons. A high molecular weight polycarbonate can contain, e.g., less than 50 ppm each of sodium, potassium, calcium, or magnesium. A high molecular weight polycarbonate can contain, e.g., less than 10 ppm of carbamate end groups. A high molecular weight polycarbonate can contain, e.g., less than 100 ppm of bromine or chlorine. A high molecular weight polycarbonate is, e.g., endcapped with an carbonate group derived from para-cumyl phenol, para-t-butyl phenol, phenol or a combination comprising at least one or the foregoing, wherein the high molecular weight polycarbonate contains a mole ratio of carbonate groups of greater than 80%. A high molecular weight polycarbonate can have, e.g., a glass transition temperature (Tg) of between 140-180° C., measured as per ASTM method D3418. A high molecular weight polycarbonate can be, e.g., a poly(carbonate-ester) (PCE); a poly(phthalate-carbonate) (PPC); polyarylate, an isoindolinone copolymer (P3PC) or any combination thereof.

The polymer blends can include one or more additives selected to achieve a desired property. The additive(s) are also selected so as to not significantly adversely affect a desired property of the polymer blend. The additive(s) can be mixed at a suitable time during the mixing of the components for forming the polymer blend. The additive(s) can be soluble and/or non-soluble in the polyaryletherketone or the high molecular weight polycarbonate. Suitable additives should have sufficient thermal stability such that they are stable and non-fugitive (i.e., it does not leach out or migrate or volatize from a polymer or blend to which it is added, either during processing or during the end use of the polymer to which the additive has been added). At high melt processing temperature, for example 300 to 380° C. One exemplary measure of such stability is that the additive does not lose more than 10% of its original weight when heated from 300 to 380° C., for example in a thermal gravimetric analysis (TGA) such as described in ASTM method E1131-08.

In some instances the additive is, e.g., a colorant, e.g., titanium dioxide or carbon black. The polymer blend can contain, e.g., up to 20 wt %, preferably up to 10 wt %, more preferably between 0.1 and 10 wt % of titanium dioxide, wherein the weight percent is based on the total weight of the polymer blend. The titanium dioxide has, e.g., a particle size of less than or equal to 10 micrometers, preferably less than or equal to 8 micrometers, more preferably between 0.1 to 5 micrometers. Although Applicant is not required to provide a description of any theory of the operation and the appended claims should not be limited by applicant statements regarding such theory, it is thought that addition of colorants such as titanium dioxide at the temperatures used can catalyze degradation of the polycarbonate. The colorants, e.g., titanium dioxide, can be passivated or encapsulated, e.g., with silanes, e.g., silicone copolymers having Si—H functionality, e.g., silica-aluminate encapsulated to improve melt stability. For example the titanium dioxide can be, e.g., passivated by treatment with a silicon compound selected from hydrogen silanes, C₁ to C₃ mono-alkoxy silanes, C₁ to C₃ di-alkoxy silanes, C₁ to C₃ tri-alkoxy silanes, or a combination comprising at least one of the foregoing.

In some instances the additive is, e.g., glass fibers, flat glass fibers, glass spheres or flakes, milled glass, carbon fibers, carbon nano tubes, carbon powder, graphite, talc, silica, fumed silica, quartz, metal fibers, metal powders such as iron, steel or tungsten, fluoro polymers such as poly(tetrafluoroethylene) (PTFE), molybdenum disulfide or a combination comprising at least one of the foregoing. A preferred glass is a borosilicate glass. To prevent degradation of the polycarbonate, it is preferred that an additive has a solution or slurry pH of from 6.0 to 8.0. Additives that do not lose more than 10% of their original weight when heated from 300 to 380° C., for example in a thermal gravimetric analysis (TGA) such as described in ASTM method E1131-08 are preferred.

The polymer blends can be manufactured by various methods. In an example, powdered polyaryletherketone, powdered high molecular weight polycarbonate, and other optional components such as additives are first blended in a high speed mixer or by hand mixing. The blend is then fed into the throat of a twin-screw extruder via a hopper. Alternatively, at least one of the components can be incorporated into the blend by feeding it directly into the extruder at the throat and/or downstream through a sidestuffer, or by being compounded into a masterbatch with a desired polymer and fed into the extruder. The extruder is generally operated at a temperature higher than that necessary to cause the blend to flow. The extrudate can be immediately quenched in a water bath and pelletized. The pellets prepared can be one-fourth inch long or less as desired. Such pellets can be used for subsequent molding, shaping, or forming.

It has been discovered that the method of preparing a polymer blend as described herein has considerations arising from the need to heat the polyaryletherketone to a temperature high enough to fully melt the polyaryletherketone crystallites (e.g., using Victrex 450 PEEK, about 360° C.). This is very far above the high molecular weight polycarbonate Tg (˜150° C.). It was discovered that it is important to use a polycarbonate with a molecular weight (Mw) and melt viscosity sufficient to allow mixing and conveying of the polyaryletherketone. Using a low melt temperature or a low Mw polycarbonate can result in polyaryletherketone unmelts, small granules of polyaryletherketone that are not fully mixed with the polycarbonate during extrusion. In some instances the extrusion can be run under vacuum. The melt blending can be, e.g., carried out in a twin screw extruder rotating at 200 to 700 revolutions per minute (rpm) preferably 300 to 400 rpm; wherein the screws each have a length to diameter (L/D) ratio from 20/1 to 40/1 with a screw diameter of from 0.5 to 10 inches; wherein the temperature at the die of the extruder is 350 to 400° C., preferably from 350 to 380° C., and the extruder is at torque of from 50 to 95%. The twin screw extruder can be, e.g., a co-rotating intermeshing twin screw extruder. The high molecular weight polycarbonate and polyaryletherketone can be undried polymer, e.g., contain at least 50 ppm water prior to melt blending. The high molecular weight polycarbonate and polyaryletherketone can be, e.g., powders, and not in pellet form.

Shaped, formed, or molded articles comprising the polymer blends are also provided. The polymer blends can be molded into useful shaped articles by a variety of methods, such as injection molding, extrusion, rotational molding, blow molding, and thermoforming. An article can be, e.g., a sheet, a film, a multilayer sheet, a multilayer film, a molded part, an extruded profile, a fiber, a coated part, or a foam. An article can have, e.g., a coefficient of thermal expansion measured as per ASTM E831-06 at 20° C. and 120° C. of from 30 to 80 micrometers/meter/° C. An article can have the coefficient of thermal expansion in the flow and cross flow directions differing by 20 micrometers/meter/° C. or less. Injection molding is the preferred route to prepare articles with a thickness of from 2.0 to 0.5 mm and a length, in some instances, at least 10 times the thickness. The molded article can further comprise snap fit connectors, ribs, vents, 3-dimensional structures and various molded-in surface textures and can be formed with metal inserts of various types or any combination thereof.

Some example of articles include computer and business machine housings such as housings for monitors, handheld electronic device housings such as housings for cell phones, electrical connectors, and components of lighting fixtures, ornaments, home appliances, roofs, greenhouses, sun rooms, swimming pool enclosures, and the like. Articles are useful in many industries and products, including, e.g., transportation, motors, oil and gas, electrical, consumer electronics, industrial, wire and cable, medical, film, appliances, helmets and sports equipment, safety equipment, enclosures, and filaments. The polymer blends can be converted to articles using known thermoplastic processes such as film and sheet extrusion. Film and sheet extrusion processes can include and are not limited to melt casting, blown film extrusion, and calendaring. Films can range from 0.1 to 1000 micrometers in some examples. Co-extrusion and lamination processes can be employed to form composite multi-layer films or sheets. Single or multiple layers of coatings can further be applied to the single or multi-layer substrates to impart additional properties such as scratch resistance, ultra violet light resistance, aesthetic appeal, etc. Coatings can be applied through standard application techniques such as rolling, spraying, dipping, brushing, or flow coating. Films and sheets can alternatively be prepared by casting a solution or suspension of the polymer blend in a suitable solvent onto a substrate, belt, or roll followed by removal of the solvent. Films can be metallized using standard processes such as sputtering, vacuum deposition, and lamination with foil. Compared to unblended PAEK the addition of polycarbonate can, in some instances, improve the bonding of various coatings, paints, and adhesives to formed parts made of PC-PAEK or PC-PEEK blends.

Oriented films can be prepared through blown film extrusion or by stretching cast or calendared films near the thermal deformation temperature using conventional stretching techniques.

The films and sheets described above can further be thermoplastically processed into shaped articles via forming and molding processes including but not limited to thermoforming, vacuum forming, pressure forming, injection molding and compression molding. Multi-layered shaped articles can be formed by injection molding a thermoplastic polymer onto a single or multi-layer film or sheet substrate as described below:

1) Providing a single or multi-layer thermoplastic substrate having optionally one or more colors on the surface, for instance, using screen printing of a transfer dye; 2) Conforming the substrate to a mold configuration such as by forming and trimming a substrate into a three dimensional shape and fitting the substrate into a mold having a surface which matches the three dimensional shape of the substrate; 3) Injecting a thermoplastic polymer into the mold cavity behind the substrate to (i) produce a one-piece permanently bonded three-dimensional product or (ii) transfer a pattern or aesthetic effect from a printed substrate to the injected polymer and remove the printed substrate, thus imparting the aesthetic effect to the molded polymer.

Those skilled in the art will also appreciate that common curing and surface modification processes including and not limited to heat-setting, texturing, embossing, corona treatment, flame treatment, plasma treatment, and vacuum deposition can further be applied to the above articles to alter surface appearances and impart additional functionalities to the articles.

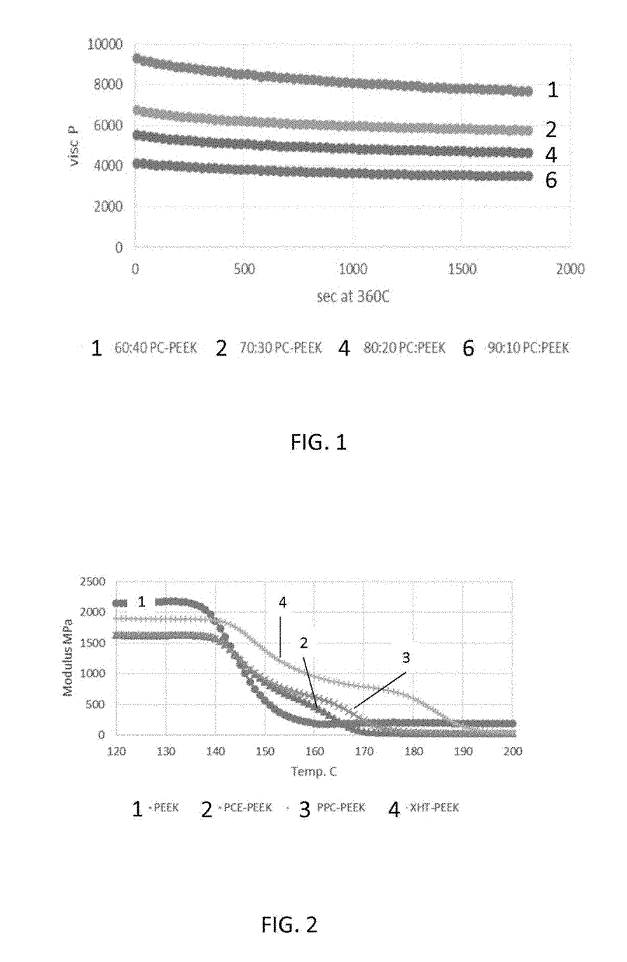

A polymer blend can have good melt stability, e.g., wherein the polymer blend retains more than 70% of the initial melt viscosity after 30 minutes at 360° C., preferably more than 80% of the initial melt viscosity after 30 minutes at 360° C., where the initial melt viscosity is between 5,000 to 20,000 Poise, measured as per ASTM method D4440-15. FIG. 1 shows good melt stability as shown by >70% retention of the initial melt viscosity of viscosity of PEEK-PC blends held at 360° C. for 30 minutes.

An article molded from a polymer blend can have, e.g., a heat distortion temperature at 264 psi of greater than or equal to 130° C., measured as per ASTM method D648-10. An article molded from a polymer blend can have, e.g., a tensile elongation at break of greater than or equal to 70%, measured as per ASTM method D638-10. An article molded from a polymer blend can have, e.g., a tensile modulus (T Mod) of at least 2000 MPa at 170° C., preferably at least 2400 MPa at 170° C., measured as per ASTM method D5418 on a 3.2 mm sample. Addition of polycarbonate reduces density (specific gravity) of the PAEK, in some instances to less than 1.25 g/cc. Specific Gravity (Sp. G.) was measured on molded parts as per ASTM method D792-00. Polycarbonate addition to PEEK also improves color, in some instances giving a YIR (yellowness index measured in reflectance) of less than 20. Yellowness index was measured in reflectance (YIR) as per ASTM E313-15 on the opaque injection molded samples.

The polymer blends are further illustrated by the following non-limiting examples.

### EXAMPLES

TABLE 1
Materials Used

| Material | Description |
|---|---|
| High Mw PC | LEXAN 130 Bisphenol A (BPA)-Polycarbonate; Mw 36,400 (PC |
| | standards); Tg 150° C.; from SABIC Co. |
| Low Mw PC | LEXAN HF BPA-Polycarbonate; Mw 21,900 (PC standards); Tg 147° C.; |
| | from SABIC Co. |
| High Mw | VICTREX 450P High Mw Polyether ether ketone; viscosity 350 Pa-s at |
| PEEK | 400° C. (ISO11443); Tg 150° C. |
| Low Mw PEEK | VICTREX 150P Low Mw Polyether ether ketone; viscosity 130 Pa-s at |
| | 400° C.; Tg 150° C. |
| PPC | LEXAN 4701, BPA iso/terephthalate polyester carbonate 80% ester; Mw |
| | 28,500 (PC standards); Tg 174° C. from SABIC Co. |
| PCE | BPA iso/terephthalate polyester carbonate 60% ester; Mw 28,350 (PC |
| | standards); Tg 172° C. |
| Silicone PC | BPA-dimethyl silicone copolymer, 8% silicone; Mw 23,000 (PC standards) |
| XHT | PPPBP (3,3-bis(4-hydroxyphenyl)-2-phenylisoindolin-1-one)/BPA |
| | copolycarbonate; Mw 24,000 g/mol, Tg 195° C. |
| TiO₂ | Silica alumina encapsulated TiO₂; 1 micrometer diameter; passivated with |
| | a silane functional methyl silicone; KRONOS K2233 |

Polymer blends were prepared by extrusion in a 30 mm (35:1 length/diameter (L/D)) co-rotating intermeshing twin-screw extruder of mixtures of the polyaryletherketone (PAEK), with a series of polycarbonates (PC). The polymers were all in powder form and were extruded with no drying. Temperatures were set at 580 to 690° F., screws were run at 280 to 300 revolutions per minute (rpm) with the feed rate adjusted from 20 to 40 lbs./hr. Feed rate and rpm where adjusted to keep torque at 70 to 90% to achieve a melt temperature at the die between 680 and 720° F. The extrudate was cooled in a water bath and pelletized for injection molding.

Samples were injection molded, after drying for at least 3 hr. at 250° F., with a melt temperature of from 680 to 720° F. using a 30 sec. cycle time and a 220° F. mold temperature to form test parts. All the PC polymers used had less than 20 ppm phenolic end groups; no detectable carbamate end groups (less than 5 ppm); and a bromine and chlorine content of each less than 50 ppm. The PC polymers had no measurable benzylic protons by H-NMR (less than 20 ppm).

Testing: Physical properties were measured using ASTM test methods, as described below. All molded samples were conditioned for at least 48 hours at 50% relative humidity prior to testing. Notched Izod impact values (N Izod) and reverse notched Izod impact values (RN Izod) were measured at room temperature on 3.2 mm thick bars as per ASTM D256-10. Heat distortion temperature (HDT) was measured at 0.46 and 1.84 MPa (66 psi and 264 psi) on 3.2 mm thick bars as per ASTM D648-10. Tensile properties; Tensile Modulus (T Mod), Tensile Strength (T Str) and Percent Elongation (% Elong) were measured on 3.2 mm type I bars as per ASTM method D638-10 with a crosshead speed of 50 mm/ min. Tensile modulus was calculated as tangent, tensile strength is reported at yield (Y), % elongation is reported at break (B). Differential scanning calorimetry (DSC) was run as per ASTM method D3418-03, but using different heating and cooling rates. Samples were heated at 20° C./min to 400 ° C. to record melting point (Tm) and cooled at 20° C./min. to record peak crystallization temperature (Tc). Tm and Tc are recorded at the peak of the transition. Dynamic Mechanical Analysis (DMA) was run in flexure on 3.2 mm bars at a heating rate of 3° C./min. with an oscillatory frequency of 1 Hertz. DMA tests were run from 40 to 200° C. as per ASTM method D5026-06. FIG. 2 shows DMA results for four samples; a PEEK control and 60:40 wt % blends of PEEK with PPC, PCE or XHT polycarbonate copolymers. Specific Gravity (Sp. G.) was measured on molded parts as per ASTM method D792-00. Multiaxial impact (MAI) values, as per ASTM D3763-14 were measured using 3.2 x 102 mm discs, impact strength is reported as total energy. Shrinkage was measured as per ASTM D955-00 on a 3.2×120 mm side gated discs in the flow and cross flow directions. Yellowness index was measured in reflectance (YIR) as per ASTM E313-15 on the opaque samples. Polycarbonate molecular weights [weight average (Mw)] were determined using gel permeation chromatography (GPC) as per ASTM method D5296-97. Polycarbonate standards were used for calibration, methylene chloride was used as the solvent. MVR (Melt Volume Ratio) was measured as per ASTM D1238-13 on samples dried for at least 1 hr. at 125° C. using a 1.2 kilogram (Kg) weight at 367° C. melt temp. MVR is reported as cc/10 min. Higher values indicate higher melt flow. Normal MVR was measured with a 6 min. equilibration at 367° C. To evaluate melt stability MVR values were also recorded with a longer 18 min. equilibration. Viscosity vs. time, also known as melt dwell or time sweep, was run using a parallel plate/cone-plate fixture rheometer at 360° C. for 30 minutes at 10 radians/sec. under nitrogen as per ASTM D4440-01. Samples were dried for at least 1 hr. at 125° C. prior to testing. Viscosity at the onset (after a 6 minute equilibration) and end of the test (30 minutes after equilibration) were compared to show the relative stability of the molten polymer. Viscosity was measured as poise (P). The change in the initial melt viscosity to the final value was determined and is reported in % retention of the initial value. FIG. 1 shows melt stability test results using this method. Chemical resistance was measured by bending an injection molded 1.6 mm×0.5×5 inch bar around a quarter ellipsoidal (oval) mandrel, often referred to as a Bergen strain jig, and exposing it to a chemical, in this case an olefinic sun screen mixture, and heating it for 3 days at 65° C. The parts were then visually examined for cracks. The distance of the first crack from the lowest curvature of the mandrel was measured, the absence of cracks or crack values above 4.0 inches indicate very good chemical resistance. Coefficient of thermal expansion (CTE) micrometers (m)/meter (m)/° C., the increase in length of a material per unit length per degree of temperature change, was measured on 3.2 mm thick bars as per ASTM E831-06. CTE is reported as the mean coefficient of linear thermal expansion within a 20 to 120° C. temperature range. Heating rate was 5° C./min with a 0.05 N load.

Table 2 shows examples 1 to 6; polymer blends of high Mw (about 36,500 g/mol, see entries in Table 2) PC with high Mw PEEK. The compounding was done as described above keeping the melt temperature from 680 to 720° F. The pellets had no unmelted PEEK.

TABLE 2
PC-PEEK Polymer blends

| | Example | | | | | |
|---|---|---|---|---|---|---|
| | 1 | 2 | 3 | 4 | 5 | 6 |
| wt % High Mw PC | 57 | 67 | 70 | 76 | 80 | 86 |
| wt % High Mw PEEK | 38 | 28 | 25 | 19 | 15 | 9 |
| wt % TiO₂ | 5 | 5 | 5 | 5 | 5 | 5 |
| MVR 6 min cc/10 min. | 7.9 | 10.3 | 10.8 | 13.5 | 14.2 | 16.2 |
| MVR 18 min cc/10 min. | 7.4 | 10.4 | 11.9 | 13.4 | 15.2 | 15.5 |
| N Izod J/m | 445 | 1190 | 1087 | 1110 | 980 | 1070 |
| (100% ductile) | | | | | | |
| RN Izod J/m | no break | no break | no break | no break | no break | no break |
| | >2140 | >2140 | >2140 | >2140 | >2140 | >2140 |
| MAI J (total E) | 89.1 | 85.1 | 81.4 | 91.9 | 85.1 | 83.5 |
| YIR | 7.2 | 7.0 | 6.5 | 6.2 | 5.8 | 5.6 |
| T Mod MPa | 2590 | 2552 | 2496 | 2456 | 2425 | 2360 |
| T Str (Y) | 69.2 | 66.1 | 65.5 | 64.4 | 63.9 | 62.7 |
| % Elong (B) | 82 | 113 | 116 | 83 | 76 | 71 |
| HDT 264 psi C | 136 | 135 | 134 | 134 | 134 | 134 |
| PC Mw (GPC) | 35202 | 35992 | 35915 | 36835 | 36533 | 35949 |
| DSC Tg° C. | 152.9 | 154.7 | 153.5 | 155.0 | 155.2 | 154.0 |
| Tm C (dH J/g) | 338 (15) | 339 (9) | 338 (10) | 338 (6) | 338 (5) | 331 (3) |
| Tc C (dH J/g) | 290 (−15) | 288 (−12) | 290 (−12) | 286 (−8) | 287 (−6) | 257 (1) |
| Dwell onset visc. P | 9305 | 6746 | 6115 | 5542 | 4348 | 4137 |
| 360° C. | | | | | | |
| Visc. after 30 min P | 7686 | 5757 | 5009 | 4662 | 3770 | 3505 |
| % visc. retention | 82.6% | 85.3% | 81.9% | 84.1% | 86.7% | 84.7% |
| Chem. Exp. 65° C. 3 day | no cracks | no cracks | no cracks | no cracks | cracked | cracked |
| | | | | | 4.9 in. | 4.7 in. |
| CTE Flow Direction | 56.6 | 60.8 | 65.0 | 64.2 | 69.3 | 64.1 |
| μm/m/° C. | | | | | | |
| CTE Cross Flow | 74.5 | 59.0 | 74.0 | 69.6 | 74.7 | 77.5 |
| μm/m/° C. | | | | | | |
| CTE Difference flow | 17.9 | 1.8 | 9.0 | 5.4 | 5.4 | 13.4 |
| direction vs cross-flow | | | | | | |
| direction | | | | | | |

The PC-PEEK polymer blends had extraordinary impact strength in all instances having a notched Izod impact above 400 J/m with 100% ductility. In some instances a notched Izod impact of over 900 J/m was achieved. Reverse notched Izod showed no break. Multi axial impact was over 70 J total energy with all samples showing only ductile failure. This is a huge improvement over the brittle nature of PEEK which has a notched Izod impact of only about 100 J/m and a reverse notched Izod of 1050 J/m with brittle failure. Tensile elongation at break of over 70% is achieved in all the polymer blends. The lower YIR values (below 8.0) show better color with increasing PC content.

An indication of enhanced dimensional stability of the PC-PEEK polymer blends are the more uniform CTE values for the polymer blends (Ex. 1-6) comparing the flow to cross flow CTE values to 100% PEEK. PEEK has a CTE of 63.0 μm/m/° C. in the flow direction with a crossflow CTE of 39.2 μm/m/° C., a difference in flow vs. cross flow of 23.8 μm/m/° C. The PC-PEEK polymer blends (Ex 1-6) have much less disparity in the flow vs. crossflow direction with CTEs ranging from 17.9 to only 1.8 μm/m/° C. This more uniform expansion in the flow and crossflow directions can facilitate part design and performance.

Note that the PEEK polymer is immiscible with the PC still retaining its crystallinity (Tm ˜340° C.) and rapid crystallization (Tc ˜290° C.) by DSC testing. Chemical exposure (Chem. Exp.) to BANANA BOAT sun screen at 65° C. for 3 days shows little or no cracking, much improved over parts made from the PC polymer which break. In addition to improved impact, better dimensional stability and improved chemical resistance, the polymer blends show better melt flow and processability at high processing temperature as seen in higher MVR values 7.9 to 16.2 cc/10 min. compared to the PEEK value of only 1.2 cc/10 min. after 6 minute equilibration at 367° C., and only 0.7 cc/10 min. after 18 minute equilibration. Also important to melt processability and retention of mechanical properties is that the polymer blends maintain viscosity (and molecular weight) vs. time in the melt at 360° C., (the temperature needed to fully melt the PEEK and ensure good mixing). The polymer blends (Ex. 1 to 6) show excellent melt viscosity retention as seen in comparing 6 and 18 minute MVR and the melt dwell test where over 80% of the initial melt viscosity is retained after 30 minutes heating (FIG. 1). This is achieved even in the presence of 5 wt % of the TiO₂ colorant.

Table 3 and FIG. 1 show the viscosity (Poise) at 360° C. for Example 1, 2, 4, and 6. Samples were equilibrated for 6 minutes (360 seconds) at 360° C. before data was recorded.

TABLE 3

| | |
|---|---|
| sec. at | Visc. Poise (P) at 360° C. |

| 360 C. | Ex. 1 | Ex. 2 | Ex. 4 | Ex6 |
|---|---|---|---|---|
| 10 | 9305 | 6746 | 5542 | 4137 |
| 300 | 8730 | 6348 | 5197 | 3920 |
| 600 | 8422 | 6145 | 5035 | 3767 |
| 900 | 8174 | 6019 | 4895 | 3668 |
| 1200 | 7975 | 5907 | 4799 | 3591 |
| 1500 | 7820 | 5838 | 4726 | 3540 |
| 1800 | 7686 | 5757 | 4662 | 3505 |

In another set of experiments, the effect of the Mw of PC and PEEK was investigated (Table 4, Examples 7 to 10). Samples were prepared as described above. Note the good dimensional stability in all polymer blends as shown by low shrinkage (<0.8%) in both the flow and cross flow direction. Having uniform shrinkage in both the flow and cross flow direction is important in having dimensionally stable parts that do not warp. Example 7 with high Mw PC and high Mw PEEK shows the excellent impact, ductility and melt stability of the earlier polymer blends (Ex. 1 to 6). However using a lower Mw PC in example 8, while still having useful properties, has a loss of ductility and shows a larger loss of viscosity in the melt after 30 min. at 360° C. Use of a lower Mw PEEK in examples 9 and 10 shows that combination with a high Mw PC with a lower Mw PEEK gives good impact and ductility. The combination of the low Mw PC and low Mw PEEK (Ex. 10) shows reduced impact, low elongation, and poor melt stability. PC Mw ≥25,000 gives superior PEEK polymer blends in these experiments.

TABLE 4
PC-PEEK Mw Effects

| | Example | | | |
|---|---|---|---|---|
| | 7 | 8 | 9 | 10 |
| wt % High Mw PC | 75 | — | 75 | — |
| wt % Low Mw PC | — | 75 | — | 75 |
| wt % High Mw PEEK | 20 | 20 | — | — |
| wt % Low Mw PEEK | — | — | 20 | 20 |
| wt % TiO₂ | 5 | 5 | 5 | 5 |
| MVR 6 min cc/10 min | 13.9 | 101 | 18.1 | 115 |
| MVR 18 min cc/10 min | 17.1 | 204 | 24.5 | 143 |
| N Izod J/m (% ductility) | 1010 (100%) | 108 (0%) | 406 (40%) | 72 (0%) |
| MAI J total E (% ductile) | 85.2 (100%) | 73.7 (60%) | 83.6 (100%) | 61 (0%) |
| YIR | 5.9 | 6.4 | 7.0 | 7.0 |
| T Mod MPa | 2482 | 2526 | 2500 | 2578 |
| T Str (Y) | 63.7 | 64.1 | 65.1 | 65.2 |
| % Elong (B) | 97 | 93 | 104 | 18 |
| HDT 264 psi C | 135 | 131 | 136 | 132 |
| PC Mw (GPC) | 35615 | 21266 | 35510 | 21570 |
| Tg | 154 | 149 | 154 | 148 |
| PEEK Tm2 (dH J/g) | 338 (6) | 338 (6) | 341 (6) | 341 (8) |
| Tc° C. (dH J/g) | 288 (−9) | 286 (−8) | 294 (−9) | 295 (−9) |
| Dwell onset visc. P 360° C. | 4364 | 1202 | 3156 | 542 |
| Visc after 30 min 360° C. | 3301 | 618 | 2551 | 440 |
| % visc. retention | 75.6% | 51.4% | 80.8% | 81.2% |
| % shrinkage flow | 0.62 | 0.71 | 0.65 | 0.67 |
| % shrinkage cross-flow | 0.65 | 0.73 | 0.68 | 0.74 |

Table 5, Examples 11 to 14, evaluate PEEK polymer blends with PC copolymers with no added TiO₂. Samples were prepared as described above. Examples 11 and 12 use two different polyester carbonate copolymers. These polymer blends give phase separated PEEK polymer blends with high impact. MVR values show that they have improved flow over PEEK. The polymer blends also have tensile elongation at break of over 70%. All the PC-PEEK polymer blends show reduced specific gravity (1.22 to 1.23 g/cc) compared to PEEK which has a Sp.G. of 1.329 g/cc. A 60:40 BPA PC-PEEK polymer blend also had reduced Sp.G. of 1.225 g/cc.

TABLE 5
PC Copolymers with PEEK

| | Example | | | |
|---|---|---|---|---|
| | 11 | 12 | 13 | 14 |
| wt % PCE | 60 | | | |
| wt % PPC | | 60 | | |
| wt % XHT | | | 60 | |
| wt % Silicone PC | | | | 60 |
| wt % High Mw PEEK | 40 | 40 | 40 | 40 |
| MVR 6 min cc/10 min. | 5.5 | 6.3 | 14.9 | 21.1 |
| MVR 18 min cc/10 min. | 5.7 | 5.9 | 90.1 | 55.6 |
| PC Mw (GPC) | 27776 | 27047 | 21371 | 22957 |
| RN Izod J/m (nb = no | >2140 | >2140 | >2140 | >2140 |
| break) | (nb) | (nb) | (nb) | (nb) |
| N Izod J/m (% ductility) | 762 (100%) | 682 (100%) | 78 (0%) | 89 (0%) |
| Lower Tg° C. (DMA) | 151.3 | 146.2 | 151.6 | 147.2 |
| Upper Tg° C. (DMA) | 169.6 | 174.6 | 191.7 | not obs. |
| HDT 66 psi° C. | 154 | 156 | 174 | 139 |
| HDT 264 psi° C. | 141 | 143 | 155 | 130 |
| PEEK Tc° C. (dH J/g) | 291 (−16) | 291 (−17) | 285 (−15) | 291 (−16) |
| PEEK Tm° C. (dH J/g) | 337 (16) | 337 (17) | 337 (18) | 340 (16) |
| T Mod MPa | 2596 | 2500 | 2966 | 2672 |
| T Str (Y) | 70.5 | 73.1 | 83.3 | 63.8 |
| % elong (B) | 83 | 113 | 92 | 13 |
| YIR | 12.3 | 12.6 | 16.8 | 18.4 |
| Dwell onset visc. P | 11648 | 10978 | 6118 | 5224 |
| Visc. 30 min 360° C. | 11481 | 10610 | 1745 | 2342 |
| % visc. retention | 98.6% | 96.6% | 28.5% | 44.8% |
| Sp.G g/cc | 1.231 | 1.232 | 1.244 | 1.222 |

The higher Tg (>150° C.) polyester carbonate polymer blends (Ex. 11 and 12) not only had improved melt flow, high impact and good melt stability they also had increased high temperature modulus above 150° C. (Table 6). The isoindolinone PC copolymer (XHT, Ex. 12.) had an even greater effect on high temperature modulus as seen in FIG. 2 and Table 6, albeit with lesser impact and poorer melt stability.

PEEK with no added PC had a 66 psi HDT of 151° C., the PCE, PPC and XHT-PEEK polymer blends had higher 66 psi HDTs of 154, 156, and 174° C. In addition to high N Izod impact the PEEK polyester carbonates (PCE and PPC) polymer blends also showed superior retention (>70%) of melt viscosity after 30 minutes at 360° C.

Modulus results for these examples are shown in FIG. 2. DMA was used to measure the flexural modulus with increasing temperature of the PEEK blends with PCE, PPC, and XHT. As can be seen in FIG. 2 the blends of Examples 11, 12, & 13 show higher modulus above about 150° C. to as high as about 185C compared to an unblended PEEK control. High temperature modulus values are shown in Table 6.

TABLE 6
PC Copolymer-PEEK Blends High Temperature Flexural Modulus

| | Flexural Modulus MPa | | | |
|---|---|---|---|---|
| | 100% | 60:40 PCE- | 60:40 PPC- | 60:40 XHT- |
| Temp. ° C. | PEEK | PEEK | PEEK | PEEK |
| 150 | 563 | 872 | 915 | 1383 |
| 155 | 301 | 655 | 738 | 1125 |
| 160 | 195 | 472 | 620 | 956 |
| 165 | 191 | 229 | 475 | 853 |

The polymer blends, methods, articles, and other aspects are further described by the Embodiments below. Embodiment 1: A polymer blend comprising: 45 to 95 weight percent (wt %), preferably 50 to 90 wt % of a polycarbonate having a weight average molecular weight greater than or equal to 25,000 g/mol and less than or equal to 80,000, preferably greater than or equal to 28,000 g/mol and less than or equal to 50,000, more preferably greater than or equal to 30,000 g/mol and less than or equal to 45,000; and 5 to 55 wt %, preferably 10 to 50 wt % of a polyaryletherketone; wherein the weight percentages are based on the total weight of the polymer blend; wherein an article molded from the polymer blend has a notched Izod impact strength greater than or equal to 400 J/m, preferably greater than or equal to 800 J/m, more preferably greater than or equal to 1000 J/m measured as per ASTM method D256-10 on a 3.2 millimeter (mm) thick sample.

Embodiment 2: The polymer blend of Embodiment 1, further comprising up to 20 wt %, preferably up to 10 wt %, more preferably between 0.1 and 10 wt % of titanium dioxide having an average particle size less than or equal to 10 micrometers, preferably less than or equal to 8 micrometers, more preferably between 0.1 to 5 micrometers, wherein the weight percent is based on total weight of the polymer blend.

Embodiment 3: The polymer blend of Embodiments 1 or 2, wherein the titanium dioxide is a silica-alumina encapsulated titanium dioxide.

Embodiment 4: The polymer blend of any one or more of Embodiments 1 to 3, wherein the titanium dioxide is silane passivated.

Embodiment 5: The polymer blend of any one or more of Embodiments 1 to 4, wherein the polymer blend retains more than 70% of the initial melt viscosity after 30 minutes at 360° C., preferably more than 80% of the initial melt viscosity after 30 minutes at 360° C., where the initial melt viscosity is between 5,000-20,000 Poise, measured as per ASTM method D4440.

Embodiment 6: The polymer blend of any one or more of Embodiments 1 to 5, wherein the polymer blend comprises a first phase comprising the polyaryletherketone and a second phase comprising the polycarbonate, and wherein the polymer blend has at least two glass transition temperatures, as measured by ASTM method D3418, wherein the first glass transition temperature is 110 to 165° C., preferably 120 to 155° C., and the second glass transition temperature is 150 to 260° C., preferably 160 to 250° C.

Embodiment 7: The polymer blend of any one or more of Embodiments 1 to 6, wherein an article molded from the polymer blend has a heat distortion temperature at 264 psi of greater than or equal to 130° C., measured as per ASTM method D648-10.

Embodiment 8: The polymer blend of any one or more of Embodiments 1 to 7, wherein an article molded from the polymer blend has a tensile elongation at break of greater than or equal to 70%, measured as per ASTM method D638-10.

Embodiment 9: The polymer blend of any one or more of Embodiments 1 to 8, wherein the polycarbonate contains less than 25 parts per million (ppm) of hydroxyl phenolic end groups, preferably less than 20 ppm of hydroxyl phenolic end groups; or less than 100 ppm of benzylic protons; or less than 50 ppm each of sodium, potassium, calcium, or magnesium; or less than 10 ppm of carbamate end groups; or less than 100 ppm of bromine or chlorine.

Embodiment 10: The polymer blend of any one or more of Embodiments 1 to 9, wherein the polycarbonate is endcapped with an carbonate group derived from para-cumyl phenol, para-t-butyl phenol, phenol, or a combination comprising at least one of the foregoing, wherein the polycarbonate contains a mole ratio of carbonate groups of greater than 80%.

Embodiment 11: The polymer blend of any one or more of Embodiments 1 to 10, wherein the polyaryletherketone is a polyaryl ether ketone, a polyaryl ketone, a polyether ketone, a polyether ether ketone, or a combination comprising at least one of the foregoing.

Embodiment 12: The polymer blend of any one or more of Embodiments 1 to 11, wherein the polyaryletherketone is a polyether ether ketone.

Embodiment 13: The polymer blend of any one or more of Embodiments 1 to 12, wherein the polyaryletherketone has a melting temperature (Tm) from 300 to 360° C.

Embodiment 14: The polymer blend of any one or more of Embodiments 1 to 13, wherein the polyaryletherketone has a crystallization temperature (Tc) from 230 to 300° C.

Embodiment 15: The polymer blend of any one or more of Embodiments 1 to 14, wherein the polyaryletherketone has a melt flow rate of between 100-500 Pa·sec at 400° C., preferably between 200-400 Pa·sec at 400° C., measured as per ISO 11443.

Embodiment 16: The polymer blend of any one or more of Embodiments 1 to 15, wherein the polycarbonate has a glass transition temperature (Tg) of 140-180° C., measured as per ASTM method D3418.

Embodiment 17: The polymer blend of any one or more of Embodiments 1 to 16, wherein an article molded from the polymer blend has a flexural modulus of at least 400 MPa at 160° C., preferably at least 600 MPa at 160° C., measured as per ASTM method D5418 on a 3.2 mm sample.

Embodiment 18: The polymer blend of any one or more of Embodiments 1 to 17, wherein the polycarbonate is a poly(carbonate-ester) (PCE); a poly(phthalate-carbonate) (PPC); a bisphenol A-dimethyl silicone copolymer; an isoindolinone polycarbonate copolymer (P3PC) or any combination thereof.

Embodiment 19: The polymer blend of any one or more of Embodiments 1 to 18, wherein the polycarbonate has a weight average molecular weight between 25,000 g/mol and 40,000 g/mol; preferably between 25,000 g/mol and 35,000 g/mol; more preferably between 25,000 g/mol and 30,000 g/mol.

Embodiment 20: The polymer blend of any one or more of Embodiments 1 to 19, comprising from 50 to 70 wt % of a polyester carbonate having a weight average molecular weight greater than or equal to 20,000 g/mol; from 30 to 50 wt % of a polyether ether ketone; wherein the weight percentages are based on the total weight of the composition; wherein an article molded from the polymer blend has a notched Izod impact strength greater than or equal to 700 J/m measured as per ASTM method D256-10 on a 3.2 mm thick sample; wherein the polymer blend retains more than 70% of the initial melt viscosity after 30 minutes at 360° C., wherein the initial melt viscosity is between 5,000-20,000 Poise, measured as per ASTM method D4440.

Embodiment 21: The polymer blend of any one or more of Embodiments 1 to 20, comprising from 60 to 90 wt % of a polycarbonate having a weight average molecular weight greater than or equal to 35,000 g/mol; from 8 to 30 wt % of a polyether ether ketone; from 1 to 6 wt % of titanium dioxide; wherein the weight percentages are based on the total weight of the composition; wherein an article molded from the polymer blend has a notched Izod impact strength greater than or equal to 900 J/m measured as per ASTM method D256-10 on a 3.2 mm thick sample; wherein the polymer blend retains more than 80% of the initial melt viscosity after 30 minutes at 360° C., where the initial melt viscosity is between 4,000-10,000 Poise, measured as per ASTM method D4440.

Embodiment 22: An article comprising the polymer blend of any one or more of Embodiments 1 to 21.

Embodiment 23: The article of Embodiment 22, wherein the article is a sheet, a film, a multilayer sheet, a multilayer film, a molded part, an extruded profile, a fiber, a coated part, or a foam.

Embodiment 24: The article of Embodiments 22 or 23, having a coefficient of thermal expansion measured as per ASTM E831-06 at 20° C. and 120° C. of 30 to 80 micrometers/meter/° C.

Embodiment 25: The article of any one or more of Embodiments 22 to 24, wherein the coefficient of thermal expansion in the flow and cross flow directions differ by 20 micrometers/meter/° C. or less.

Embodiment 26: A method of preparing a polymer blend, comprising: melt blending from 45 to 95 wt %, preferably from 50 to 90 wt % of a polycarbonate having a weight average molecular weight between 25,000 g/mol and 80,000 g/mol; and from 5 to 55 wt %, preferably from 10 to 50 wt % of a polyaryletherketone; wherein the weight percentages are based on the total weight of the polymer blend.

Embodiment 27: The method of Embodiment 26, wherein the melt blending is in a twin screw extruder rotating at 200 to 700 revolutions per minute, preferably 300 to 400 revolutions per minute; wherein the screws each have a length to diameter (L/D) ratio from 20/1 to 40/1; wherein the temperature at the die of the extruder is 350 to 400° C.; and wherein the extruder is at torque of from 50 to 95%.

Embodiment 28: The method of any one of more of Embodiments 26 to 27, wherein the polycarbonate and polyaryletherketone each contain at least 50 ppm water prior to melt blending.

Embodiment 29: The method of any one or more of Embodiments 26 to 28, wherein the polycarbonate and polyaryletherketone are powders.

Embodiment 30: The method of any one or more of Embodiments 26 to 29, wherein the twin screw extruder is a co-rotating intermeshing twin screw extruder wherein the screws have a length to diameter (L/D) ratio from 20/1 to 40/1 with a screw diameter from 0.5 to 10 inches.

Embodiment 31: The method of any one or more of Embodiments 26 to 30, wherein the extruder is under vacuum of a pressure of at least 10 inches mercury.

Embodiment 32: A method of preparing the polymer blend of any of Embodiments 1-21, comprising: melt blending from 45 to 95 wt %, preferably from 50 to 90 wt % of a polycarbonate having a weight average molecular weight between 25,000 g/mol and 80,000 g/mol; and from 5 to 55 wt %, preferably from 10 to 50 wt % of a polyaryletherketone; wherein the weight percentages are based on the total weight of the polymer blend.

The singular forms “a,” “an,” and “the” include plural referents unless the context clearly dictates otherwise. The terms “first,” “second,” and “the like,” as used herein do not denote any order, quantity, or importance, but rather are used to distinguish one element from another. “Or” means “and/or.” The modifier “about” used in connection with a quantity is inclusive of the stated value and has the meaning dictated by the context (e.g., includes the degree of error associated with measurement of the particular quantity). The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group. The suffix “(s)” is intended to include both the singular and the plural of the term that it modifies, thereby including at least one of that term (e.g., the additives(s) includes at least one additive). “Optional” or “optionally” means that the subsequently described event or circumstance can or cannot occur, and that the description includes instances where the event occurs and instances where it does not. A “combination” is inclusive of blends, mixtures, alloys, and he like. Reference throughout the specification to “one embodiment,” “another embodiment,” “an embodiment,” and so forth, means that a particular element (e.g., feature, structure, and/or characteristic) described in connection with the embodiment is included in at least one embodiment described herein, and can or cannot be present in other embodiments. In addition, it is to be understood that the described elements and components can be combined in any suitable manner in the various embodiments.

Unless defined otherwise, technical and scientific terms used herein have the same meaning as is commonly understood by one of skill in the art to which this invention belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While typical examples have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A polymer blend comprising:
45 to 95 weight percent (wt %) of a polycarbonate having a weight average molecular weight greater than or equal to 25,000 g/mol and less than or equal to 80,000; and
5 to 55 wt % of a polyaryletherketone;
wherein the weight percentages are based on the total weight of the polymer blend;
wherein an article molded from the polymer blend has a notched Izod impact strength greater than or equal to 400 J/m measured as per ASTM method D256-10 on a 3.2 millimeter (mm) thick sample.

2. The polymer blend of claim 1, further comprising up to 20 wt % of titanium dioxide having an average particle size less than or equal to 10 micrometers, wherein the weight percent is based on total weight of the polymer blend.

3. The polymer blend of claim 1, wherein the titanium dioxide is a silica-alumina encapsulated titanium dioxide.

4. The polymer blend of claim 1, wherein the titanium dioxide is silane passivated.

5. The polymer blend of claim 1, wherein the polymer blend retains more than 70% of the initial melt viscosity after 30 minutes at 360° C., where the initial melt viscosity is between 5,000 to 20,000 Poise, measured as per ASTM method D4440.

6. The polymer blend of claim 1, wherein the polymer blend comprises a first phase comprising the polyaryletherketone and a second phase comprising the polycarbonate, and wherein the polymer blend has at least two glass transition temperatures, as measured by ASTM method D3418, wherein the first glass transition temperature is 110 to 165° C., and the second glass transition temperature is 150 to 260° C.

7. The polymer blend of claim 1, wherein an article molded from the polymer blend has a heat distortion temperature at 264 psi of greater than or equal to 130° C., measured as per ASTM method D648-10.

8. The polymer blend of claim 1, wherein an article molded from the polymer blend has a tensile elongation at break of greater than or equal to 70%, measured as per ASTM method D638-10.

9. The polymer blend of claim 1, wherein the polycarbonate contains less than 25 ppm of hydroxyl phenolic end groups; or less than 100 ppm of benzylic protons; or less than 50 ppm each of sodium, potassium, calcium, or magnesium; or less than 10 ppm of carbamate end groups; or less than 100 ppm of bromine or chlorine.

10. The polymer blend of claim 1, wherein the polycarbonate is endcapped with an carbonate group derived from para-cumyl phenol, para-t-butyl phenol, phenol, or a combination comprising at least one of the foregoing, wherein the polycarbonate contains a mole ratio of carbonate groups of greater than 80%.

11. The polymer blend of claim 1, wherein the polyaryletherketone is a polyaryl ether ketone, a polyaryl ketone, a polyether ketone, a polyether ether ketone, or a combination comprising at least one of the foregoing.

12. The polymer blend of claim 1, wherein the polyaryletherketone has at least one of the following:
a melting temperature (Tm) from 300 to 360° C.;
a crystallization temperature (Tc) from 230 to 300° C.; and
a melt flow rate of between 100 to 500 Pa·sec at 400° C., measured as per ISO 11443.

13. The polymer blend of claim 1, wherein an article molded from the polycarbonate has a glass transition temperature (Tg) of 140 to 180° C., measured as per ASTM method D3418.

14. The polymer blend of claim 1, wherein the polymer blend has a flexural modulus of at least 400 MPa at 160° C. measured as per ASTM method D5418 on a 3.2 mm sample.

15. The polymer blend of claim 1, wherein the polycarbonate is a poly(carbonate-ester) (PCE); a poly(phthalate-carbonate) (PPC); a bisphenol A-dimethyl silicone copolymer; an isoindolinone polycarbonate copolymer (P3PC) or any combination thereof.

16. The polymer blend of claim 1, comprising from 50 to 70 wt % of a polyester carbonate having a weight average molecular weight greater than or equal to 20,000 g/mol; from 30 to 50 wt % of a polyether ether ketone; wherein the weight percentages are based on the total weight of the composition; wherein an article molded from the polymer blend has a notched Izod impact strength greater than or equal to 700 J/m measured as per ASTM method D256-10 on a 3.2 mm thick sample; wherein the polymer blend retains more than 70% of the initial melt viscosity after 30 minutes at 360° C., wherein the initial melt viscosity is between 5,000 to 20,000 Poise, measured as per ASTM method D4440.

17. The polymer blend of claim 1, comprising from 60 to 90 wt % of a polycarbonate having a weight average molecular weight greater than or equal to 35,000 g/mol; from 8 to 30 wt % of a polyether ether ketone; from 1 to 6 wt % of titanium dioxide; wherein the weight percentages are based on the total weight of the composition; wherein an article molded from the polymer blend has a notched Izod impact strength greater than or equal to 900 J/m measured as per ASTM method D256-10 on a 3.2 mm thick sample; wherein the polymer blend retains more than 80% of the initial melt viscosity after 30 minutes at 360° C., where the initial melt viscosity is between 4,000 to 10,000 Poise, measured as per ASTM method D4440.

18. A method of preparing the polymer blend of claim 1, comprising:
melt blending from 45 to 95 wt % of a polycarbonate having a weight average molecular weight between 25,000 g/mol and 80,000 g/mol; and
from 5 to 55 wt % of a polyaryletherketone;
wherein the weight percentages are based on the total weight of the polymer blend.

19. The method of claim 18, wherein the melt blending is in a twin screw extruder rotating at 200 to 700 revolutions per minute; wherein the screws each have a length to diameter (L/D) ratio from 20/1 to 40/1; wherein the temperature at the die of the extruder is 350 to 400° C.; and wherein the extruder is at torque of from 50 to 95%.

20. An article comprising the polymer blend of claim 1.
